(19) United States
(12) Patent Application Publication
(10) Pub. No.: US 2020/0229397 A1
(43) Pub. Date: Jul. 23, 2020

(54) Dog Toy with Crinkle Stretch Parts

(71) Applicant: DELCA CORPORATION, Mission Viejo, CA (US)

(72) Inventor: Sabine S. Crane, San Clemente, CA (US)

(21) Appl. No.: 16/747,307

(22) Filed: Jan. 20, 2020

Related U.S. Application Data
(60) Provisional application No. 62/794,408, filed on Jan. 18, 2019.

(51) Int. Cl. A01K 15/02; G10K 9/04

(52) U.S. Cl. CPC A01K 15/025; G10K 9/04

(57) ABSTRACT

A dog toy has a noisemaking bellows having an elastic component axially therethrough in one or more parts. The bellows allows the corresponding part to stretch and makes a crackling sound during stretching, and then return to its original length making additional crackling sounds during retraction, both of which aid in retaining the attention of a dog playing with the toy. More than one bellows may be present in a toy, such as two or four bellows in the limbs of an animal-shaped toy. Bellows may be in different parts of the toy, depending on where it is desired that the toy be stretchable. For example, a bellows could be placed in the torso of an animal-shaped toy, allowing the body of the toy overall to be stretched rather than just a limb or limbs.

### RELATED APPLICATION

This application claims priority to U.S. Provisional Patent Application Ser. No. 62/794,408 for a “Dog Toy with Crinkle Stretch Parts,” filed Jan. 18, 2019, and currently co-pending, the entirety of which is incorporated herein by reference.

### FIELD OF THE INVENTION

The present invention pertains generally to toys for use in entertaining pets. More particularly, the present invention pertains to a toy with noisemaking stretchable parts. The Present invention is particularly, but not exclusively, useful as a dog toy.

### BACKGROUND OF THE INVENTION

Humans and dogs have associated with each other for thousands of years. Some remains of what are thought to be domesticated dogs date back to the Paleolithic era. Today, dogs may be kept to guard livestock, hunt, or perform other types of labor, but it is also common for dogs to be kept as pets.

It is common to purchase toys for one's pets. Pet toys provide recreation and exercise for animals kept as pets. Pet toys, including dog toys, have become a major industry, and dog toys can be found in virtually every department store in the United States as well as in pet stores.

### SUMMARY OF THE INVENTION

Disclosed is a dog toy having a noisemaking bellows in one or more parts. The bellows allows the corresponding part to stretch and makes a crackling sound during stretching. More than one bellows may be present in a toy, such as two or four bellows in the limbs of an animal-shaped toy. Bellows may be in different parts of the toy, depending on where it is desired that the toy be stretchable. For example, a bellows could be placed in the torso of an animal-shaped toy, allowing the body of the toy overall to be stretched rather than just a limb or limbs.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a cutaway view of a toy with stretch legs, showing the noisemaking bellows of one leg;

FIG. 2 is a side view of a toy with a stretch torso showing the extendable bellows with an integral elastic element allowing the torso to expand and contract lengthwise;

FIG. 3 illustrates a noisemaking bellows in a closed or resting configuration;

FIG. 4 illustrates a noisemaking bellows in an open or stretched configuration; and

FIG. 5 illustrates a partially open bellows.

### DETAILED DESCRIPTION

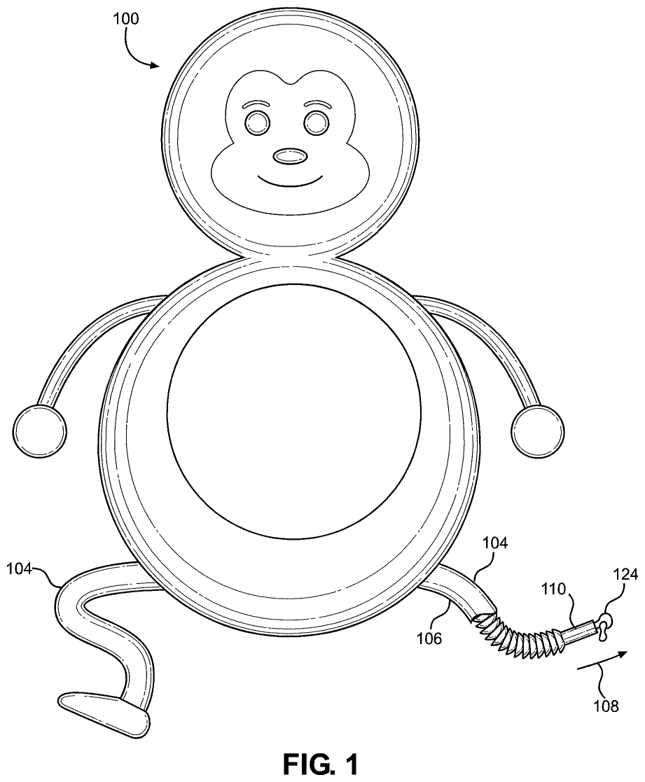

Referring initially to FIG. 1, a toy 100 with stretch legs 104 is shown. Stretch legs 104 comprise a covering 106 of a stretchable material or loose cloth over a noisemaking bellows 110, allowing stretch legs 104 to be extended in direction 108 from an initial length to an extended length that is greater than the initial length. The noisemaking bellows 110 generates a crackling sound when stretch legs 104 are extended or retracted. An elastic component 120 passes through the central lumen 111 of bellows 110 and is secured in place with knots 122 and 124 to secure the elastic component 120 in place and to provide a contracting force to bellows 110.

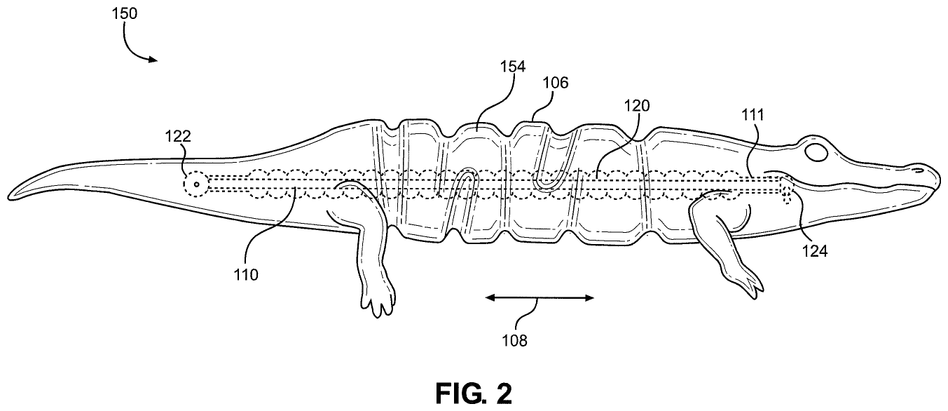

Referring now to FIG. 2, a toy 150 in the exemplary form of an alligator with a stretch torso 154 is shown. Stretch torso 154 comprises a covering 106 of stretchable material or loose cloth over a noisemaking bellows 110, allowing stretch torso 154 to be extended from an initial length to an extended length greater than the initial length when stretched along its length in direction 108. The noisemaking bellows 110 generates a crackling sound when stretch torso 154 is extended or retracted. The noisemaking bellows 110 in various embodiments of the dog toy with crinkle stretch parts may vary in size and length according to the particular toy and which parts stretch. However, despite variances in length and cross-sectional diameter, noisemaking bellows 110 has a similar structure in its various embodiments.

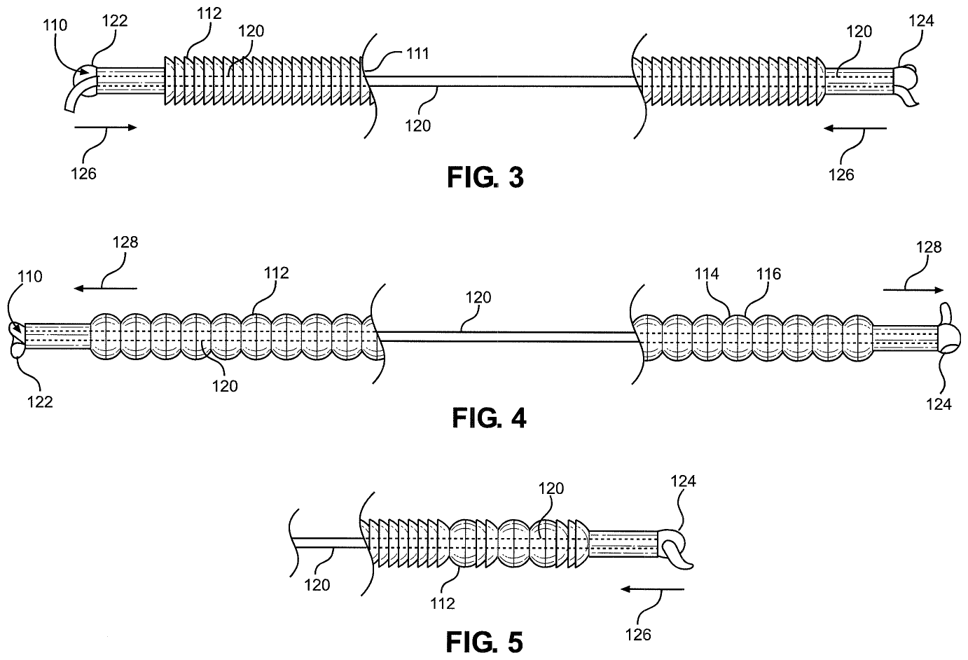

Referring now to FIG. 3, a noisemaking bellows 110 is shown in its contracted or resting configuration. Bellows 110 comprises a long tube with an accordion-like structure and having a central lumen 111. Each bellows element 112, or “fold” in the tube, can expand from the contracted state to the extended state, and contract from the extended state to the contracted state. This transition between expanded and contracted states is rapid, and at the moment when the bellows element 112 changes configuration between its contracted and extended state, it emits a snap sound which, when combined with other bellows elements 112 changing configuration, combine to make a crinkling sound that is appealing to dogs. When all the bellows elements are in the contracted state, as depicted in FIG. 5, the bellows 110 is at its minimum length and considered to be fully in its contracted configuration.

A preferred embodiment of noisemaking bellows 110 is made from a plastic material. Other suitable materials may be used so long as the bellows 110 emits a snapping noise when transitioning between the expanded and contracted states.

Expansion or contraction is accompanied by a snapping sound as the bellows element snaps from one configuration into another. Specifically, each bellows element 112 includes a first part 114 and an adjacent second part 116 that can change configurations between a first configuration wherein first part 114 is immediately adjacent and partially within second part 116, and a second configuration wherein the first part 114 is extending away from second part 116. The transition between this first and second configuration results in a crackling sound as multiple bellows elements change from one configuration to the other. This provides aural stimulation to a dog using the toy, keeping the dog's interest. Referring now to FIG. 4, bellows 110 is shown in its extended configuration. When bellows 110 is in its fully extended configuration, each bellows element is in an extended state. Expansion is accomplished by putting sufficient outward force on the ends of the bellows 110 in direction 128, pulling the bellows elements into their extended configuration. This occurs when the stretchable portion of a toy of the present invention, such as toy 100 or toy 150, is pulled on, for example, if a dog pulls the portion away while the dog's owner is holding another portion of the toy. When the force in direction 128 is removed, the return force of elastic component 120 pulls in direction 126 and the bellows 110 returns to its contracted configuration due to the elastic contraction of the elastic element 120, and the stretchable portion of the toy returns to its lesser length.

Referring now to FIG. 5, bellows 110 is shown in a partially extended, partially retracted configuration. In a partially extended configuration, some bellows elements 112 are in the extended state while others are in the contracted state.

Elastic element 120, in a preferred embodiment, is made from rubber tubing. The rubber tubing is well suited for this application as it is easily cut to appropriate lengths, is relatively impervious to the gnawing efforts of most dogs, and readily available. Other elastic component materials may be used without departing from the present invention. Other elastic component materials may include, but not be limited to, elastic bands, rubber bands, springs, or any other material having a longitudinally stretchable characteristic suitable for placement within lumen 111 of bellows 110 and secured in place.

While there have been shown what are presently considered to be preferred embodiments of the present invention, it will be apparent to those skilled in the art that various changes and modifications can be made herein without departing from the scope and spirit of the invention.

What is claimed is:

1. A toy, comprising:
a toy body; and
at least one noisemaking bellows,
wherein a first noisemaking bellows of the at least one noisemaking bellows is located within an extendable portion of the toy body such that the first noisemaking bellows generates a crackling sound when the extendable portion of the toy body is extended or retracted.

2. The toy as recited in claim 1, wherein the toy body comprises an animal shape having an extendable torso, and wherein the first noisemaking bellows is located in the extendable torso.

3. The toy as recited in claim 1, wherein the toy body comprises an animal shape having a first extendable leg and a second extendable leg, wherein the first noisemaking bellows is located in the first extendable leg, and wherein a second noisemaking bellows is located in the second extendable leg.

4. The toy as recited in claim 1, wherein the first noisemaking bellows is made from a plastic material.

5. A toy, comprising:
a toy body having at least one extendable portion,
wherein each extendable portion of the at least one extendable portion comprises a bellows comprising a tube with an accordion-like structure and formed with a lumen; and
an elastic element passing through said lumen providing a contracting force to said bellows.

6. The toy as recited in claim 5, wherein the toy body comprises an animal shape and the at least one extendable portion comprises a torso portion of the animal shape.

7. The toy as recited in claim 5, wherein the toy body comprises an animal shape and the at least one extendable portion consists of a torso portion of the animal shape.

8. The toy as recited in claim 5, wherein the toy body comprises an animal shape and the at least one extendable portion comprises a plurality of limbs of the animal shape.

9. The toy as recited in claim 5, wherein the toy body comprises an animal shape and the at least one extendable portion consists of a plurality of limbs of the animal shape.

10. The toy as recited in claim 9, wherein the plurality of limbs consists of two limbs.

11. The toy as recited in claim 9, wherein the plurality of limbs consists of four limbs.

12. A toy, comprising:
a toy body comprising an extendable portion comprising a covering and a noisemaking bellows covered by the covering,
wherein the covering is selected from the group consisting of stretchable material and loose cloth, and
wherein the noisemaking bellows is configured to generate a noise while the extendable portion is extended.

13. The toy as recited in claim 12, wherein the noisemaking bellows is formed with a lumen having an elastic element therethrough and configured to retract when force associated with extending the extendable portion is removed.

14. The toy as recited in claim 12, wherein the toy body comprises an animal shape.

15. The toy as recited in claim 12, wherein the noisemaking bellows comprises a plastic material.

16. The toy as recited in claim 12, wherein the noisemaking bellows comprises a tube with an accordion-like structure.

17. The toy as recited in claim 16, wherein the noisemaking bellows generates a crackling sound while the extendable portion is extended.

18. The toy as recited in claim 17, wherein the noisemaking bellows generates a crackling sound while the extendable portion is retracted.

19. The toy as recited in claim 17, wherein the noisemaking bellows comprises a plurality of bellows elements, each bellows element having a contracted configuration and an extended configuration.

20. The toy as recited in claim 19, wherein the crackling sound comprises a combination of snapping sounds, each snapping sound generated by a bellows element of the plurality of bellows elements during expansion from a contracted configuration to an extended configuration.
